(19) United States
(12) Patent Application Publication
(10) Pub. No.: US 2022/0235478 A1
(43) Pub. Date: Jul. 28, 2022

(54) METHOD AND PLANT FOR PRODUCING A CARBON-MONOXIDE-RICH GAS PRODUCT

(71) Applicant: Linde GmbH, Pullach (DE)

(72) Inventors: Andreas PESCHEL, Wolfratshausen (DE); Benjamin HENTSCHEL, München (DE)

(21) Appl. No.: 17/596,977

(22) PCT Filed: Sep. 22, 2020
(86) PCT No.: PCT/EP2020/025430

§ 371 Date: Dec. 22, 2021

(30) Foreign Application Priority Data
Oct. 18, 2019 (DE) 10 2019 007 265.0

(51) Int. Cl. C25B 15/08; C25B 1/23

(52) U.S. Cl. CPC C25B 15/083; C25B 15/085; C25B 1/23

(57) ABSTRACT

A method for producing a carbon-monoxide-rich gas product, in which method at least carbon dioxide is subjected to electrolysis, so as to obtain an untreated gas comprising at least carbon monoxide and carbon dioxide, and in which method the untreated gas is subjected to a separation process, which comprises an adsorption and membrane separation, so as to obtain a recycling stream, which comprises the major part of the carbon dioxide contained in the untreated gas, a residual gas, and the carbon-monoxide-rich gas product. A plant for carrying out such a method is also proposed.

The present invention relates to a method and to a plant for producing a gas product rich in carbon monoxide according to the respective preambles of the independent patent claims.

### PRIOR ART

Carbon monoxide can be produced by means of a number of different methods, for example together with hydrogen by steam reforming natural gas and subsequent purification from the synthesis gas formed, or by gasification of feedstocks, such as coal, natural gas, petroleum or biomass and subsequent purification from the synthesis gas formed.

The electrochemical production of carbon monoxide from carbon dioxide is likewise known and appears to be attractive in particular for applications in which the classical production by steam reforming is overdimensioned and thus uneconomical. For example, high-temperature electrolysis, which is carried out using one or more solid oxide electrolysis cells (SOEC), can be used for this purpose. Oxygen forms on the anode side, and carbon monoxide forms on the cathode side, according to the following generalized chemical equation:

CO₂→CO+½O₂ (1)

As a rule, carbon dioxide is not entirely converted into carbon monoxide during the electrochemical production of carbon monoxide during a single pass through the electrolysis cell(s), which is why carbon dioxide is typically at least partially separated from an untreated gas formed during electrolysis and fed back to the electrolysis.

The explained electrochemical production of carbon monoxide from carbon dioxide is described, for example, in WO 2014/154253 A1, WO 2013/131778 A2, WO 2015/014527 A1 and EP 2 940 773 A1. Separation of the untreated gas formed during electrolysis using absorption, adsorption, membrane, and cryogenic separation methods is also disclosed in the cited publications, but no details regarding the specific embodiment or a combination of the methods are given. A combination of adsorption and membrane separation is known from DE 10 2017 005 681 A1 and WO 2018/228717A1, but here the separation sequence disclosed is a different separation sequence than in the present invention.

In solid oxide electrolysis cells, water can also be subjected to electrolysis, in addition to carbon dioxide, so that a synthesis gas containing hydrogen and carbon monoxide can be formed. Details in this regard are described, for example, in an article by Foit et al., Angew. Chem. 2017, 129, 5488-5498, DOI: 10.1002/ange.201607552, which was published online before going to press. Such methods can also be used in the context of the present invention.

The electrochemical production of carbon monoxide from carbon dioxide is also possible by means of low-temperature electrolysis on aqueous electrolytes. To put it generally, the following reactions take place:

CO₂+2e⁻+2M⁺+H₂O→CO+2MOH (2)

2MOH→½O₂+2M⁺+2e⁻ (3)

For a corresponding low-temperature electrolysis, a membrane is used, through which the positive charge carriers (M⁺) required according to chemical equation 2, or formed according to chemical equation 3, diffuse from the anode side to the cathode side. In contrast to high-temperature electrolysis, the positive charge carriers here are not transported in the form of oxygen ions, but, for example, in the form of positive ions of the electrolyte salt used (a metal hydroxide, MOH). An example of a corresponding electrolyte salt may be potassium hydroxide. In this case, the positive charge carriers are potassium ions. Further embodiments of low-temperature electrolysis include, for example, the use of proton exchange membranes through which protons migrate, or of so-called anion exchange membranes. Different variants of corresponding methods are described, for example, in Delacourt et al., J. Electrochem. Soc. 2008, 155, B42-B49, DOI: 10.1149/1.2801871.

The presence of water in the electrolyte solution partially results in the formation of hydrogen at the cathode in accordance with:

2H₂O+2M⁺+2e⁻→H₂+2MOH (4)

Depending on the catalyst used, additional useful products can also be formed during low-temperature electrolysis. In particular, low-temperature electrolysis can be carried out to form varying amounts of hydrogen. Corresponding methods and devices are described, for example, in WO 2016/124300 A1 and WO 2016/128323 A1.

During high-temperature (HT) co-electrolysis, which is carried out using solid oxide electrolysis cells (SOEC), the following cathode reactions are observed or postulated:

CO₂+2e⁻→CO+O²⁻ (5)

H₂O+2e⁻→H₂+O²⁻ (6)

The following anode reaction also proceed:

2O²⁻→O₂+4e⁻ (7)

In this case, the oxygen ions are conducted substantially selectively over a ceramic membrane from the cathode to the anode.

It is not entirely clarified whether the reaction according to chemical equation 5 proceeds in the manner shown. It is also possible for only hydrogen to be formed electrochemically and for carbon monoxide to form according to the reverse water-gas shift reaction in the presence of carbon dioxide:

CO₂+H₂⇄H₂O+CO (8)

Normally, the gas mixture formed during high-temperature co-electrolysis is (or is approximately) in water-gas shift equilibrium. However, the specific manner in which the carbon monoxide is formed has no effect on the present invention.

The separation method disclosed in the aforementioned DE 10 2017 005 681 A1 for separating the untreated gas formed during electrolysis comprises only a separation of the unreacted carbon dioxide; the electrolysis products pass into the gas product together. The production of carbon monoxide is possible with this method only with impurities in a non-negligible amount. The separation method known from the aforementioned WO 2018/228717 A1 can lead to adverse effects in certain cases, in particular in the case of larger product quantities.

The object of the present invention is, therefore, to improve the purity of a gas product rich in carbon monoxide in a corresponding separation and at the same time the yield in relation to the quantity of raw material used.

### DISCLOSURE OF THE INVENTION

Against this background, the present invention proposes a method for producing a gas product rich in carbon monoxide and a corresponding plant having the features of the respective independent patent claims. Preferred embodiments are the subject matter of the dependent claims and the following description.

Before further explaining the present invention and its advantageous embodiments, the terms used are defined and further principles of the present invention are explained.

All data relating to proportions of mixtures used within the scope of the present disclosure refer to the volume fraction in each case.

A “gas product rich in carbon monoxide” is understood here to mean in particular carbon monoxide of different purities, which is formed by means of the method according to the invention. Accordingly, in addition to carbon monoxide, other gas components can also be contained, which, however, constitute a volume fraction of less than 40%, 30%, 20%, 10%, 5%, 3%, 2%, 1%, 0.5%, 0.3%, 0.2%, 0.1%, 100 ppm or 10 ppm, in each case based on the entire product volume of the gas product. Such other gas components may in particular be carbon dioxide and/or hydrogen.

Any gas mixture provided using electrolysis to which carbon dioxide is subjected (among other things or exclusively), is referred to as “untreated gas” in the language used herein. In addition to the explicitly mentioned components, the untreated gas may also contain, for example, oxygen or unreacted inert components, wherein “inert” in the language used herein is to be understood as “unreacted during electrolysis” and is not limited to classical inert gases.

The electrolysis process carried out within the scope of the present invention can be carried out using one or more electrolysis cells, one or more electrolyzers, each having one or more electrolysis cells, or one or more other structural units suitable for electrolysis. In the context of the present invention, this is or these are configured in particular to carry out low-temperature electrolysis with aqueous electrolytes, as explained at the outset.

Alternatively, as mentioned, high-temperature electrolysis may also be provided. In such a case, it is understood that the one or more electrolysis cells are also configured for such a method. In this case, in particular no aqueous electrolytes are provided, but rather solid electrolytes, for example of a ceramic nature and/or based on transition metal oxides.

In general, streams of material, gas mixtures, etc., in the language as used herein, may be “enriched” in or “depleted” of one or more components, with these terms referring in each case to a corresponding content in a starting mixture. They are “enriched” if they contain at least 1.1 times, 1.5 times, 2 times, 5 times, 10 times, 100 times, or 1000 times the content of one or more components, and “depleted” if they contain at most 0.9 times, 0.75 times, 0.5 times, 0.1 times, 0.01 times, or 0.001 times the content of one or more components, relative to the starting mixture.

The terms “streams of material”, “gas mixtures”, etc. as used herein may also be “rich” or “low” in one or more components, wherein the term “rich” may represent a content of at least 50%, 60%, 75%, 90%, 99%, 99.9% or 99.99% and the term “low” may represent a content of at most 50%, 40%, 25%, 10%, 1%, 0.1%, 0.01% or 0.001%. When a plurality of components is specified, the term “rich” or “low” refers to the sum of these components. For example, if “carbon monoxide” is mentioned here, this may refer to a pure gas, but also to a mixture rich in carbon monoxide. A gas mixture containing “predominantly” one or more components is particularly rich in this or these components in the sense discussed.

A “permeate” is understood here and subsequently to mean a gas mixture obtained in a membrane separation process, which predominantly or exclusively has components that are not or are not entirely retained by the membrane used in the membrane separation process, i.e., which at least partially pass through the membrane. Within the scope of the invention, membranes are used which preferably retain carbon monoxide and allow other components to preferably pass through. In this way, these other components accumulate in the permeate. Such membranes can be, for example, commercial polymer membranes used extensively for separating hydrogen and/or carbon dioxide. Accordingly, a “retentate” within the meaning of this disclosure is a mixture consisting predominantly or exclusively of components that are at least partially retained by the membranes used in the membrane separation process. A passage of the respective components can be set by the corresponding choice of the membrane.

### Embodiments and Advantages of the Invention

Overall, the present invention proposes a method for producing a gas product that is rich in carbon monoxide in the sense explained above, in which at least carbon dioxide is subjected to an electrolysis process to obtain an untreated gas containing at least carbon monoxide and carbon dioxide. With regard to the electrolysis methods that can be used in the method, reference is made to the explanations above. The present invention is described below in particular with reference to low-temperature electrolysis, but high-temperature electrolysis is also easily possible in various embodiments, wherein, as already mentioned, here too hydrogen, for example, can arise in the untreated gas.

Therefore, when it is mentioned here that “at least carbon dioxide” is subjected to the electrolysis process, this does not preclude further components of a feed mixture, in particular water, for example, from also being supplied and subjected to the electrolysis process. In particular, in the case of high-temperature electrolysis, the supply of hydrogen and carbon monoxide into the electrolysis process can have a positive effect on the service life of the electrolysis cell(s) due to the setting of reducing conditions caused thereby.

Within the scope of the present invention, the electrolysis process can take place in the form of high-temperature electrolysis using one or more solid oxide electrolysis cells or as low-temperature electrolysis, for example using a proton exchange membrane and an electrolyte salt in aqueous solution, in particular a metal hydroxide. In principle, low-temperature electrolysis can be carried out using different liquid electrolytes, for example on an aqueous basis, in particular with electrolyte salts, on a polymer basis, on an organic solvent basis, on an ionic liquids basis or in other embodiments. In low-temperature electrolysis, due to the presence of water, in particular as a component of the electrolyte, there is typically always a certain formation of hydrogen, which formation is variable depending on the embodiment of the method. In high-temperature electrolysis, hydrogen can also occur in the untreated gas, for example by a formation of hydrogen due to the presence of water vapor as a contaminant in the raw materials used or by the targeted addition of hydrogen to the electrolysis process, as described above. Typically, no targeted co-electrolysis of carbon dioxide and water is carried out in the present invention.

According to the invention, heat exchangers and/or other heating devices or cooling devices can be used to set the temperature in electrolysis and/or the membrane separation process. In this case, corresponding heat exchangers can be designed particularly advantageously in such a way that a mixture leaving a method step transfers its heat energy to a mixture supplied to the method step (“feed-effluent heat exchanger”).

The untreated gas formed in the electrolysis process can have, in particular in the non-aqueous portion (i.e., “dry”), a content of 0% to 20% hydrogen, 10% to 90% carbon monoxide and 10% to 90% carbon dioxide. Its water content depends on the temperature and the pressure and can, for example, be 10% to 60% at 80° C. and 100 kPa. Percentages herein and below relate to the volume or mole fraction.

In the context of the present invention, it is further provided for the untreated gas to be partially or entirely subjected to adsorption by obtaining a recycling stream enriched in carbon dioxide and depleted of carbon monoxide and other components in comparison to the untreated gas and an intermediate product depleted of carbon dioxide and enriched in carbon monoxide and other components in comparison to the untreated gas. According to the invention, the intermediate product is furthermore partially or entirely subjected to a membrane separation process as a retentate by obtaining a carbon-monoxide-rich gas product enriched in carbon monoxide and depleted of hydrogen and other components in comparison to the intermediate product, and as a permeate by obtaining a residual gas depleted of carbon monoxide and enriched in hydrogen and other components in comparison to the intermediate product, wherein the recycling stream, and thus the carbon dioxide contained therein, is at least partially recirculated to the electrolysis process, and the residual gas is at least partially recirculated to the adsorption process together with the untreated gas.

An essential aspect of the present invention thus consists in processing an untreated gas from the electrolysis process, which, due to the electrolysis conditions used, contains at least carbon monoxide and carbon dioxide, but can also contain appreciable amounts of hydrogen, by initially using adsorption, in particular pressure swing adsorption, vacuum pressure swing adsorption and/or temperature swing adsorption, before a membrane separation is carried out.

The water contained in the untreated gas is advantageously partially or entirely removed from the untreated gas before it is supplied to the adsorption process. In one embodiment of the present invention, the separated water can be partially or entirely recirculated to the electrolysis process.

The arrangement according to the invention of the adsorption process before membrane separation results in several advantages which positively influence the separation performance. Water is thus removed from the untreated gas already prior to membrane separation, which brings about energy savings during the process. The (almost) quantitative separation, by adsorption, of the carbon dioxide contained in the untreated gas results in a lower volumetric load on the membrane in the downstream membrane separation process, whereby higher stability and better separation performance can be achieved. Since a higher quantity of by-products, such as hydrogen, can be discharged in the residual gas, the yield of carbon monoxide is also increased in relation to the quantity of carbon dioxide used.

As already mentioned, an intermediate product and a gas mixture referred to herein as a “recycling stream” are formed during the adsorption process. The intermediate product is particularly strongly depleted of carbon dioxide, since the latter adsorbs on the adsorbent used during the adsorption process. Carbon monoxide is distributed, in particular, between the intermediate product and the recycling stream, wherein the proportions can be influenced by the selection of corresponding adsorption conditions.

In contrast, hydrogen, if present, passes predominantly into the intermediate product. The intermediate product is therefore low in or free of carbon dioxide and can predominantly or exclusively consist of carbon monoxide and possibly hydrogen. The intermediate product contains, for example, less than 5%, 4%, 3%, 2%, 1%, 0.5%, 0.1%, 500 ppm, 100 ppm, 50 ppm, 10 ppm, or 1 ppm carbon dioxide and otherwise contains 50% to 99% carbon monoxide, 0% to 20% hydrogen as well as any inert components and impurities not removed by the adsorption process, for example methane, nitrogen, and/or argon.

During the membrane separation process, the gas product rich in carbon monoxide is formed as retentate and a gas mixture referred to herein as residual gas, which gas mixture is formed using permeate portions.

In the gas product rich in carbon monoxide, hydrogen and carbon dioxide are depleted compared to the intermediate product and carbon monoxide is enriched. In particular, carbon dioxide is hardly contained in particular to an appreciable extent. The gas product contains, for example, 90% to 100% carbon monoxide, 0‰ to 1‰ carbon dioxide, 0% to 1% hydrogen and any inert components and impurities that have not been separated during the membrane separation process, for example methane, nitrogen and/or argon.

The residual gas contains the majority of the hydrogen contained in the intermediate product and is otherwise substantially composed of carbon monoxide and carbon dioxide. However, since the latter has advantageously already been largely removed during the adsorption process, the residual gas is low in carbon dioxide.

A further essential aspect of the present invention consists in recirculating portions of the recycling stream (together with fresh feed) to the electrolysis process and/or recirculating portions of the residual gas (together with the untreated gas) to the adsorption process. In this way, advantageous conditions for the process steps can be set by adapting the composition of the respective feed. In particular, carbon dioxide can be recirculated to the electrolysis process and carbon monoxide to the separation process in a targeted or more targeted manner. This is advantageous since according to the principle of least constraint, and depending on the design, the electrolysis of carbon dioxide to carbon monoxide is promoted if there is an excess of carbon dioxide.

In this way, carbon dioxide contained in the untreated gas can be used to improve the yield of a corresponding method by partially or entirely recirculating it to the electrolysis process. Here too it applies that when speaking of recirculating “carbon dioxide” to the electrolysis process, this does not preclude further components from being intentionally or unintentionally recirculated to the electrolysis process.

The recirculation of the carbon monoxide contained in the residual gas to the adsorption process increases the product yield since it can ultimately be transferred into the gas product in this way and is not lost via the residual gas. In addition, the addition of residual gas to the untreated gas reduces the concentration of carbon dioxide before entering the adsorption process, which has an advantageous effect on process management, in particular with respect to pressure adjustment.

Within the scope of the present invention, a simple, cost-effective on-site production of carbon monoxide by carbon dioxide electrolysis becomes possible according to one of the described techniques. In this way, carbon monoxide can be provided to a consumer, without having to resort to the known methods, such as steam reforming, which may be overdimensioned. High demands on the purity of the gas product rich in carbon monoxide can thereby be met. The production on site makes it possible to dispense with a cost-intensive and potentially unsafe transport of carbon monoxide. Within the scope of the present invention, a flexible cleaning of an untreated gas provided by means of electrolysis of carbon dioxide to high-purity carbon monoxide products with recirculation of carbon dioxide to the electrolysis process and particularly efficient process control are possible.

Within the scope of the present invention, at least one fresh feed containing at least predominantly carbon dioxide can be fed to the electrolysis process, in addition to the recycling stream. This fresh feed may, for example, have a content of more than 90%, 95%, 99%, 99.9% or 99.99% carbon dioxide. The higher this proportion, the fewer by-products are formed during electrolysis, and the lower the proportion of foreign components that must be separated from the untreated gas. However, as already mentioned, it can be advantageous to the service life of the electrolysis cell(s) if, in addition to carbon dioxide, hydrogen and/or carbon monoxide are also supplied to the electrolysis process, so that, under certain conditions, further components that are, for example, advantageous for process management can be introduced into the fresh feed.

As already mentioned, the use of a suitable membrane separation process downstream of the adsorption process can prevent undesirably high amounts of by-products from entering the gas product that is rich in carbon monoxide. In particular, the separation performance and the service life of the membrane can be improved by recirculating the recycling stream to the electrolysis process while bypassing membrane separation.

In one embodiment of the method according to the invention, the membrane separation process comprises at least a first and a second membrane separation step, wherein the permeate is formed by using permeate portions from the first and/or second separation step. According to one embodiment of the present invention, it may also be provided for the membrane separation process to comprise a first and a second membrane separation step, and for the permeate of one of the membrane separation steps to be supplied to the input mixture of another of the membrane separation steps in order to enhance the yield and/or purity under pressure increase by means of a compressor.

It is particularly advantageous within the scope of the present invention that at least some of the residual gas (which is incidentally recirculated to the process) is discharged from the process. For example, it can be provided within the scope of the present invention that a partial stream is branched off from the residual gas in the form of a so-called purge. The components contained in a corresponding purge are discharged from the process and thus withdrawn from the process. By discharging components, which in particular behave inertly and/or are undesirable in the carbon monoxide gas product, they can be prevented from accumulating in the circuits formed as a result of recirculation.

According to one embodiment of the present invention, it can also be provided, particularly advantageously, for the membrane separation process to comprise a first and a second membrane separation step, wherein a membrane is used in one of the two membrane separation steps that produces a permeate that is particularly rich in by-products, in particular hydrogen and/or inert components. In such an embodiment according to the invention, it is particularly advantageous to form the purge using the correspondingly enriched permeate and to discharge it from the process since it is, in particular, low in carbon monoxide and carbon dioxide and thus the loss of carbon monoxide and/or carbon dioxide can be minimized.

In the context of the present invention, it is provided for the electrolysis to be carried out at an electrolysis pressure level, adsorption to be carried out at an adsorption pressure level, and membrane separation to be carried out at a membrane pressure level. The adsorption pressure level and the membrane pressure level are in each case the inlet pressures into the respective method steps. In the language used herein, a first pressure level is “at” a second pressure level when the two pressure levels differ from each other by not more than 0.1 MPa, 0.2 MPa, 0.3 MPa or 0.5 MPa. In the language used herein, a first pressure level is “above” a second pressure level when it is, in particular, more than 0.5 MPa and up to 3 MPa above the first pressure level.

According to the invention, electrolysis can be operated at the (inlet or upper) pressure level of the adsorption process (which in the case of pressure swing adsorption is, for example, 1 MPa to 8 MPa, preferably 1 MPa to 4 MPa) or at a lower pressure level. In the first case, the untreated gas does not have to be compressed or has to be compressed only to a small extent. For this purpose, the recycling stream must be compressed to the electrolysis pressure level since it leaves the adsorption process at a desorption pressure level, which in the case of pressure swing adsorption is significantly below the adsorption pressure level. In the second case, the untreated gas or its proportion supplied to the adsorption process must be compressed to the adsorption pressure level, wherein compressing the recycling stream before feeding it to the electrolysis process can optionally be dispensed with. In a further embodiment according to the present invention, the adsorption process can be designed as a vacuum pressure swing adsorption. The adsorption pressure level is then at the electrolysis pressure level (for example, 100 kPa to 1000 kPa, preferably 100 to 500 kPa) and the desorption pressure level (for example, 20 kPa to 90 kPa, preferably 30 kPa to 70 kPa) is below the electrolysis pressure level. As a result, only relatively weak compressors are required, which results in an advantage with regard to investment, safety and maintenance effort. Depending on the priority, the person skilled in the art will thus select the most advantageous variant for the specific application, considering the individual advantages.

In one embodiment of the present invention, the permeate from the membrane separation process can be recirculated to the electrolysis process via the same compressor as the recycling stream from the adsorption process.

It is thus possible to cut down on one compressor.

In the context of the present invention, an untreated gas is advantageously formed having a content of 10% to 95% carbon monoxide, 0% to 10% hydrogen and 5% to 90% carbon dioxide.

In order to increase the conversion of carbon dioxide, a recirculation of some of the untreated gas to the electrolysis process can advantageously be provided.

The present invention also covers a plant for producing a gas product rich in carbon monoxide, according to the corresponding independent patent claim.

As regards the features and advantages of the plant proposed according to the invention, reference is made explicitly to the above explanations regarding the method according to the invention and its embodiments. This also applies to a system according to a particularly preferred embodiment of the present invention, which is designed to carry out a method as was described above in the embodiments thereof.

The invention is described in more detail hereafter with reference to the accompanying drawings, which illustrate preferred embodiments of the present invention.

### BRIEF DESCRIPTION OF THE DRAWINGS

FIG. 1 illustrates a method according to an embodiment of the invention.

FIG. 2 illustrates a method according to an embodiment of the invention.

FIG. 3 illustrates a method according to an embodiment of the invention.

FIG. 4 illustrates a method according to an embodiment of the invention.

In the figures, method steps, technical units, apparatuses, and the like, which correspond to one another in terms of their function and/or design or structure, bear identical reference signs and, for the sake of clarity, are not repeatedly explained. Although methods according to the invention are illustrated in the figures and are explained in more detail below, these figures and explanations apply in the same way to the corresponding plants according to the invention.

### DETAILED DESCRIPTION OF THE DRAWINGS

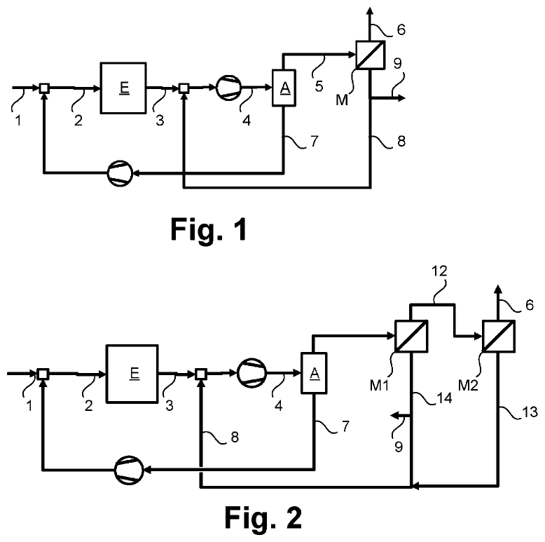

FIG. 1 schematically shows a method according to an embodiment of the invention.

An electrolysis E, which can be carried out as explained at the outset, is provided as an essential step of the method.

An electrolysis feed 2, which is rich in carbon dioxide and is supplied to the electrolysis, contains carbon dioxide. The carbon dioxide is partially reacted to carbon monoxide during electrolysis E, which carbon monoxide passes from the cathode side of the electrolysis unit(s) into the untreated gas 3 where further components may also be contained depending on the electrolysis conditions and the components of the electrolysis feed 2. The oxygen arising on the anode side as explained at the beginning is not shown in the figures and is removed from the method. Also not shown are the addition, separation, and discharge or recycling of water, as well as possible heat exchangers and/or external heat sources, which can be used as described above.

In the exemplary embodiment shown, the untreated gas contains, for example, about 1% hydrogen, 34% carbon monoxide and 65% carbon dioxide, based on the dry untreated gas. It is formed, for example, in an amount of approximately 500 Nm³/h and is present at the electrolysis pressure level of approximately 0 kPa to 100 kPa above the atmospheric pressure, for example approximately 150 kPa absolute. After compression to the adsorption pressure level (for example, 2 MPa), it is fed entirely to an adsorption A as part of an adsorption feed 4 explained below according to the present embodiment according to the invention. The temperatures used in an electrolysis are, for example, in a range of 20° C. to 80° C., for example approximately 60° C. Complete conversion of the carbon dioxide used is generally not desired in order to protect the electrolysis material or is not possible from a reaction kinetics point of view, which is why the untreated gas also contains carbon dioxide.

During adsorption A, the adsorption feed 4, which contains, for example, approximately 3% hydrogen, 38% carbon monoxide and 58% carbon dioxide and which is provided, for example, in a quantity stream of approximately 550 Nm³/h, is processed. Here, an intermediate product 5, which contains, for example, approximately 9% hydrogen, 91% carbon monoxide and 0.1% carbon dioxide, is formed in a quantity of, for example, approximately 160 Nm³/h and a recycling stream 7 is formed, which consists, for example, of approximately 0.4% hydrogen, 17% carbon monoxide and 82% carbon dioxide and comprises, for example, approximately 390 Nm³/h.

The recycling stream 7 is compressed by the desorption pressure level, which is, for example, approximately 120 kPa, by means of a compressor to the electrolysis pressure level and is mixed with a fresh feed 1, which comprises, for example, approximately 110 Nm³/h pure carbon dioxide, to give the electrolysis feed 2, which has about 0.2% hydrogen, 14% carbon monoxide and 86% carbon dioxide and is provided in an amount of about 500 Nm³/h.

According to the embodiment of the invention illustrated herein, the intermediate product 5 is fed to a membrane separation M downstream of the adsorption A without adjusting the pressure. The membrane pressure level is accordingly at the adsorption pressure level, as explained above. In the membrane separation according to the embodiment of the invention shown in FIG. 1, for example approximately 100 Nm³/h of a carbon monoxide gas product 6 having a composition of, for example, approximately 0.1% hydrogen, 99.9% carbon monoxide and 100 ppm carbon dioxide and approximately 60 Nm³/h of a residual gas 8 and 9, which consists, for example, of approximately 22% hydrogen, 78% carbon monoxide and 0.2% carbon dioxide, are formed.

In the embodiment of the invention illustrated in FIG. 1, some of the residual gas, for example approximately 10 Nm³/h, is removed from the process as purge 9 having the same composition as the residual gas. The remaining portion of the residual gas 8 is mixed with the untreated gas 3 downstream of the electrolysis E to obtain the adsorption feed 4 and is compressed.

The method according to an embodiment of the present invention illustrated in FIG. 2 differs from the method illustrated in FIG. 1 in particular by the multi-stage design of the membrane separation. The intermediate product 5 is accordingly processed in a first membrane separation step M1 to obtain a first retentate 12 and a first permeate 14. The first membrane separation step M1 is carried out, for example, in such a way that a high concentration of hydrogen is achieved in the first permeate 14, for example a proportion of more than 25%. The first retentate is processed in a second membrane separation step M2 to obtain a second retentate 13 and the carbon monoxide gas product 6. The residual gas 8, which is formed using the permeates 13 and 14, is mixed with the untreated gas 3 downstream of the electrolysis E to form the adsorption feed 4 and is compressed. In this embodiment of the process, the purge 9 to be removed from the process can be particularly advantageously removed from the first permeate 14 since the loss of carbon monoxide and carbon dioxide can thus be minimized, as already described.

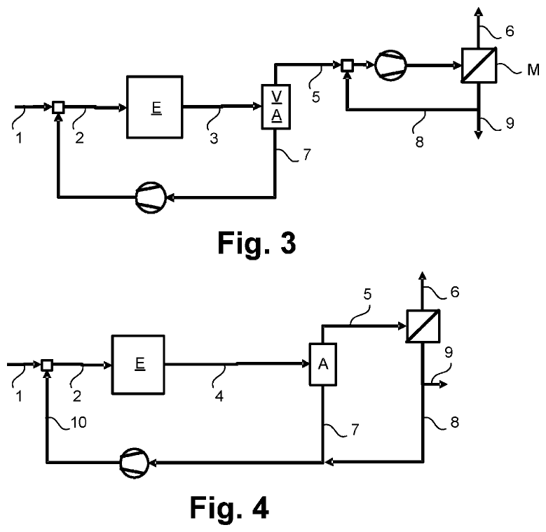

FIG. 3 illustrates an embodiment of the method according to the invention in which adsorption is carried out in the form of a vacuum pressure swing adsorption VA. In this case, the untreated gas 3 is subjected to vacuum pressure swing adsorption VA, wherein compression of the adsorption feed can be dispensed with. In this embodiment of the invention, the electrolysis pressure level essentially corresponds to the adsorption pressure level of, for example, approximately 150 kPa. In the illustrated embodiment of the invention, the residual gas 8 formed in the membrane separation M is compressed together with the intermediate product 5 to the membrane pressure level of, for example, approximately 2 MPa and is recirculated to the membrane separation M.

FIG. 4 illustrates an embodiment in the context of the present invention in which the electrolysis E is carried out in the form of high-pressure electrolysis at an electrolysis pressure level of, for example, approximately 2 MPa. Compression of the untreated gas to form the adsorption feed 4 can also be dispensed with in this embodiment. Adsorption A is carried out at the electrolysis pressure level. In the embodiment illustrated, the residual gas 8 from the membrane separation M is compressed together with the recycling stream 7 to form a recycling feed 10, which, together with the fresh feed 1, is recirculated as electrolysis feed 2 to the electrolysis E. Compression steps can be saved by combining the various streams to be recirculated as well as the pressure levels of electrolysis E, adsorption A and membrane separation M.

1-12. (canceled)

13. A method for producing a carbon-monoxide-rich gas product, in which method at least carbon dioxide is subjected to electrolysis, so as to obtain an untreated gas comprising at least carbon monoxide and carbon dioxide, and in which method the untreated gas is subjected to a separation process, which comprises an adsorption and membrane separation, so as to obtain a recycling stream, which comprises the majority of the carbon dioxide contained in the untreated gas, a residual gas, and the carbon-monoxide-rich gas product, wherein the recycling stream is partially or entirely recirculated to the electrolysis,
wherein
the untreated gas is partially or entirely subjected to the adsorption so as to obtain the recycling stream and an intermediate product stream which is carbon-monoxide-enriched and carbon-dioxide-depleted in relation to the untreated gas,
and that the intermediate product stream is partially or entirely subjected to the membrane separation so as to obtain the gas product and the residual gas,
wherein the residual gas is partially or entirely recirculated to the adsorption.

14. The method according to claim 13, wherein the adsorption comprises pressure swing adsorption, vacuum pressure swing adsorption and/or temperature swing adsorption.

15. The method according to claim 13, wherein some of the residual gas is discharged from the method.

16. The method according to claim 13, wherein the adsorption separates 90%-100% of the carbon dioxide contained in the untreated gas into the recycling stream.

17. The method according to claim 13, wherein the membrane separation comprises at least a first membrane separation step and a second membrane separation step, wherein the retentate of the first membrane separation step is separated further partially or entirely in the second membrane separation step, wherein the gas product is formed using the retentate of the second membrane separation step, and wherein the residual gas is formed using permeate portions of the at least two membrane separation steps.

18. The method according to claim 13, wherein the pressure at which the electrolysis is carried out is not more than 100 kPa, 200 kPa, 300 kPa or 500 kPa different from the pressure at which the adsorption is carried out.

19. The method according to claim 13, wherein the pressure at which the adsorption is carried out is 0.5 MPa to 3 MPa higher than the pressure at which the electrolysis is carried out.

20. The method according to claim 13, wherein the carbon monoxide gas product contains 90%-100% carbon monoxide.

21. The method according to claim 13, wherein at least 20 Nm³/h of the carbon monoxide gas product is formed.

22. The method according to claim 13, wherein some of the untreated gas is recirculated to the electrolysis.

23. A plant for producing a carbon monoxide gas product having an electrolysis unit, which is configured to subject at least carbon dioxide to an electrolysis so as to obtain an untreated gas containing at least carbon monoxide and carbon dioxide, and
having means configured to subject the untreated gas to a separation process, which comprises an adsorption and membrane separation, so as to obtain a recycling stream, which comprises the majority of the carbon dioxide contained in the untreated gas, a residual gas, and the carbon monoxide gas product, with means configured to partially or entirely recirculate the recycling stream to the electrolysis,
wherein
means which are configured to partially or entirely subject the untreated gas to the adsorption so as to obtain the recycling stream and an intermediate product stream which is carbon-monoxide-enriched and carbon-dioxide-depleted in relation to the untreated gas, and
means which are configured to partially or entirely subject the intermediate product stream to the membrane separation so as to obtain the gas product and the residual gas,
with means configured to partially or entirely recirculate the residual gas to the adsorption.

24. A plant for producing a carbon monoxide gas product having an electrolysis unit, which is configured to subject at least carbon dioxide to an electrolysis so as to obtain an untreated gas containing at least carbon monoxide and carbon dioxide, and
having means configured to subject the untreated gas to a separation process, which comprises an adsorption and membrane separation, so as to obtain a recycling stream, which comprises the majority of the carbon dioxide contained in the untreated gas, a residual gas, and the carbon monoxide gas product, with means configured to partially or entirely recirculate the recycling stream to the electrolysis,
wherein
means which are configured to partially or entirely subject the untreated gas to the adsorption so as to obtain the recycling stream and an intermediate product stream which is carbon-monoxide-enriched and carbon-dioxide-depleted in relation to the untreated gas, and
means which are configured to partially or entirely subject the intermediate product stream to the membrane separation so as to obtain the gas product and the residual gas,
with means configured to partially or entirely recirculate the residual gas to the adsorption,
wherein said plant for producing a carbon monoxide gas product having an electrolysis is configured to carry out the method according to claim 13.
